(19) United States
(12) Patent Application Publication
(10) Pub. No.: US 2019/0368639 A1
(43) Pub. Date: Dec. 5, 2019

(54) THREADED CONNECTION OF CASING PIPES

(71) Applicant: TMK-PREMIUM SERVICES LLC, Moscow (RU)

(72) Inventors: Boris Urievich SHCHERBAKOV, Taganrog (RU); Yury Fedorovich EMELIANOV, Taganrog (RU); Vladimir Petrovich ALDOHIN, Taganrog (RU); Pavel Nikolaevich SIDORENKO, Taganrog (RU); Aleksey Sergeevich MYSLEVTCEV, Taganrog (RU)

(21) Appl. No.: 16/431,770

(22) Filed: Jun. 5, 2019

(30) Foreign Application Priority Data
Jun. 5, 2018 (RU) RU 2018120779

(51) Int. Cl. F16L 15/06; E21B 17/042

(52) U.S. Cl. CPC F16L 15/06; E21B 17/042

(57) ABSTRACT

Threaded connections of casing pipes comprising male and female members with trapezoidal tapered threads arranged on outer and inner surfaces of end sections. Radial sealing surfaces and stop end surfaces contact forming an internal sealing zone. Threads on male and female members have a 1:16 taper ratio, a 23-25° stab flank angle, and a −3 to −5° load flank angle. During assembly, crests and stab flanks of thread profile form clearances. Radial sealing surfaces on male and female members are tapered and positioned at a 71-73° angle relative to the normal. Stop end surfaces on male and female members are positioned at a 14-16° angle relative to the normal. Stop end thickness of male member constitutes at least 50% of wall thickness. Tight sealing of connection is preserved under considerable combined loads, including high-torque exposure.

### CROSS-REFERENCE TO RELATED APPLICATION

This application claims priority to Russian Application no. RU 2018120779 filed on Jun. 5, 2018. The earliest priority date claimed is Jun. 5, 2018.

### FEDERALLY SPONSORED RESEARCH

None

### SEQUENCE LISTING OR PROGRAM

None

### BACKGROUND

The proposed utility model relates to threaded connections of casing pipes and can be used for connecting elements of casing strings utilized during the construction of inclined and horizontal wells in oil, gas and gas-condensate fields. The proposed connection can be also used when rotating a casing string in the process of lowering and cementing, as well as while performing casing drilling.

The casing pipes used in oil, gas and gas-condensate fields operate under complex conditions, including exposure to aggressive working media and considerable combined multidirectional mechanical loads (tension, compression, bending). Therefore, the main requirement to the threaded connections of casing pipes is to maintain tight sealing, including gas-tight sealing, under the specified complex operating conditions. When rotating a casing string in the process of lowering, and when using casing pipes for cementing and casing drilling, an important characteristic of the connection if its high-torque resistance.

A threaded connection of casing pipes is known from the prior art, which comprises male and female members with trapezoidal tapered buttress threads arranged along the outer and inner surfaces of the end sections thereof. The thread profile of such connection has a negative load flank angle. In addition, the connection produces an internal sealing zone formed by the contacting radial sealing (tapered) and stop end surfaces. The stop end surfaces form a 5-25° angle relative to the line perpendicular to the central axis of the thread (RU 2338866 C1, Nov. 20, 2008) [1].

The threaded connection of casing pipes disclosed in [1] does not provide tight sealing of the connection in case of exposure to considerable combined multidirectional loads, nor does it provide the required high-torque resistance.

The technical solution referenced in [1] was chosen as a prototype of the proposed utility model.

The objective of the proposed utility model is to create a threaded connection of casing pipes with improved technical and performance characteristics, which would ensure tight sealing under particularly complex operating conditions (maximum combined bending, compressive, and tensile loads), high-torque resistance, and demonstrate improved assembly and disassembly characteristics.

The technical result provided by the proposed utility model consists in maintaining tight sealing of the connection under considerable combined mechanical loads (tension, compression, bending), including high-torque exposure, and improving the assembly and disassembly characteristics of the connection.

The connection comprises male and female members with trapezoidal tapered threads arranged, respectively, along the outer and inner surfaces of the end sections thereof, as well as radial sealing surfaces and stop end surfaces contacting with each other to form an internal sealing zone.

The threads on the male and female members have a taper ratio of 1:16. The stab flank angle relative to the normal line to the central axis of the thread is 23-25°, and the load flank angle relative to the normal line to the central axis of the thread is from −3 to −5°. During assembly of the connection, the crests and stab flanks of the thread profiles form clearances between them. The radial sealing surfaces of the male and female members are tapered and positioned at an angle of 71-73° relative to the normal line to the central axis of the thread. The stop end surfaces of the male and female members are positioned at an angle of 14-16° relative to the normal line to the central axis of the thread. The thickness of the stop end of the male member constitutes at least 50% of the wall thickness of the male member.

### DRAWINGS

FIG. 1 shows the assembled threaded connection of casing pipes.

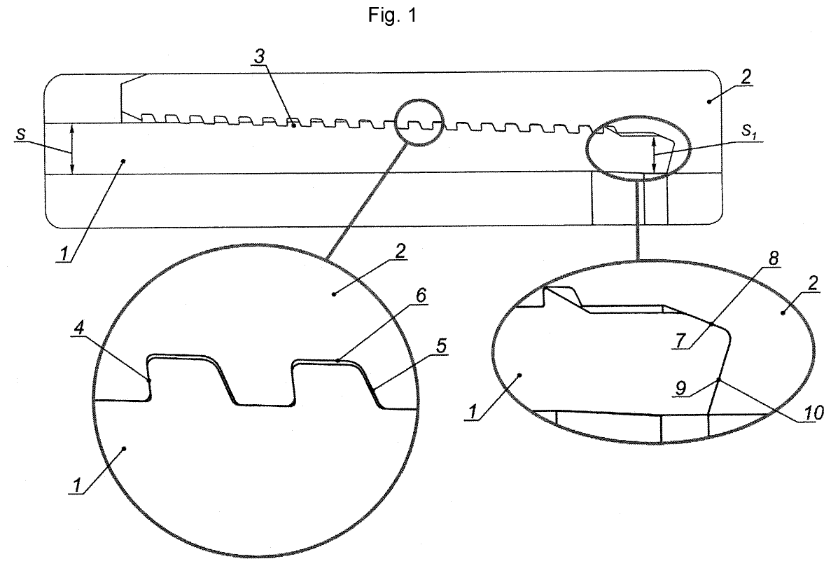

### DESCRIPTION

The threaded connection of casing pipes comprises male (1) and female (2) members with trapezoidal tapered threads (3) arranged along the outer and inner surfaces of the end sections thereof.

The threads (3) on the male (1) and female (2) members have a taper ratio of 1:16. Providing threads (3) with the taper ratio of 1:16, on the one hand, ensures high degree of mating engagement thereof during assembly of the connection, as well as the ability to accommodate bending and tensile loads experienced by the connection in the process of operation, and, on the other hand, allows to maintain high-performance characteristics assembly and disassembly of the connection (a possibility of repeated screwing and unscrewing of the connection, as well as prevention of jamming of the connection during assembly).

The thread profile (3) represents a non-isosceles trapezoid with the lateral faces embodied in the form of a load flank (4) and a stab flank (5).

The angle of the stab flank (5) of the thread (3) profile on the male (1) and female (2) members constitutes 23-25° relative to the normal line to the central axis of the thread, and the angle of the load flank (4) of the thread (3) profile constitutes from −3 to −5° relative to the normal line to the central axis of the thread.

The normal line to the central axis of the thread is a line perpendicular to the central line of the thread.

Making the value of the angle of the stab flank (5) of the thread (3) profile equal to 23-25° relative to the normal line to the central axis simplified assembly and disassembly of the connection by providing distinct stabilization of the male (1) and female (2) member position with respect to each other at the initial stage of assembly, which prevents the connection from jamming and damaging (tearing up) the thread (3) surfaces. This also facilitates quick assembly of the connection.

The negative inclination angle (from −3 to −5° relative to the normal line to the central axis of the thread (3)) of the contacting load flanks (4) of the thread (3) profile excludes the possibility of mutual disengagement of the thread (3) turns on the male (1) and female (2) members under the effect of even more considerable tensile loads. This also allows achieving resistance of the connection towards bending loads.

During assembly, the crests (6) of the thread (3) profile of the male (1) and female (2) members form a clearance between them.

The clearance between the crests (6) of the thread (3) profile of the male (1) and female (2) members provides for an improved assembly and disassembly of the connection and increases the wear resistance thereof. It also helps removing the excess of lubricant during assembly of the connection, the accumulation of which on the contacting surfaces of the connection reduces the sealing quality.

During assembly of the connection, another clearance is also formed along the stab flanks (5), which improves the characteristics of assembly and disassembly of the connection by providing a possibility of repeated screwing and unscrewing it without damaging (tearing up) the contacting surfaces of the threads, and prevents the connection from jamming during assembly, while preserving its performance characteristics.

The connection is configured to have an internal sealing formed by contacting radial sealing surfaces (7), (8) and stop end surfaces (9), (10) provided on the male (1) and female (2) members of the connection.

The presence of sealing zone in the connection, the radial sealing surfaces (7), (8) and stop end surfaces (9), (10) of which contact with each other creating considerable contact stresses, provides a high degree of sealing of the connection under multidirectional combined mechanical loads by developing deformation in the elastic region resulting in “metal-to-metal” type sealing.

The radial sealing surfaces (7), (8) of the connections are embodied in the form of the tapered surfaces located at an angle of 71-73° relative to the normal line to the central axis of the thread (3).

The radial sealing surfaces (7), (8) provide high-quality sealing of the entire connection design due to “metal-to-metal” type sealing formed as a result of contact between the radial sealing surfaces (7), (8) and characterized by considerable contact stresses and developed deformation of the surfaces (7), (8) in the elastic region. To ensure high reliability and tight sealing of the connection, the radial sealing surfaces (7), (8) are machined with high degree of precision and surface finish.

Positioning the radial sealing surfaces (7), (8) at an angle of 71-73° relative to the normal line to the central axis of the thread (3) allows achieving required tension at a relatively small axial displacement of the female member (2), which reduces the duration from the first contact between the sealing surfaces (7), (8) to achieving the required tension (how quick the sealing surfaces can be coupled and decoupled within the contact zone). This guarantees better wear resistance of the connection during repeated screwing and unscrewing. This also ensures the optimal contact area between the sealing surfaces (7), (8), as well as high level of contact stresses providing tight sealing of the connection under any combination of the affecting loads.

The stop end surfaces (9), (10) are positioned at an angle of 14-16° relative to the normal line to the central axis of the thread (3).

Positioning the stop end surfaces (9), (10) at an angle of 14-16° relative to the normal line to the central axis of the thread (3) ensures “pre-compression” and secures the radial sealing surfaces (7), (8) of the connection, which makes it resistant towards compressive loads and provides an additional sealing barrier. Besides, this ensures a distinct mutual positioning of the male (1) and female (2) members, as well as achieving of the precise tension and torque values during the connection assembly process, thus, yielding the improved characteristics of assembly and disassembly, as well as better control of the connection assembly process.

The thickness (S₁) of the stop end of the male member (1) of the connection constitutes at least 50% of the wall thickness (S) of the male member (1).

The increased thickness of the stop end of the male member (1) increases the mutual contact area of the stop end surfaces (9), (10) during assembly of the connection allows preserving the functional ability thereof under considerable torque and compressive force, as well as precisely secure the provision of the internal sealing zone and the thread with respect to each other by maintaining the preset tension values.

The threaded connection of casing pipes operates as follows.

When performing the connection assembly operation, the male (1) and female (2) members first interact by means of the trapezoidal tapered threads (3) arranged on the outer surface of the end section of the male member (1) and inner surface of the end section of the female member (2).

As the connection is screwed together, the radial sealing surface (7) of the male member (1) advances along the sealing surface (8) of the female member (2) and interacts therewith. As a result of the deformation of the radial sealing surfaces (7) and (8), a “metal-to-metal” type seal is created.

At the same time, the interaction between stop end surfaces (9) and (10) takes place.

The process of screwing together the connection ends upon mating of the stop end surfaces (9) and (10) arranged on the male (1) and female (2) members.

What is claimed:

1. A threaded connection of casing pipes, comprising male and female members with trapezoidal tapered threads arranged, respectively, on the outer and inner surfaces of the end sections thereof, as well as radial sealing surfaces and stop end surfaces, positioned at a angle of 14-16° relative to the normal line to the central axis of the thread and contacting with each other to form an internal sealing zone, characterized in that the threads on the male and female members have taper ratio of 1:16, the stab flank angle relative to the normal line to the central axis of the thread is 23-25°, the load flank angle relative to the normal line to the central axis of the thread is from −3 to −5°, and the crests and stab flanks of the thread profiles form clearances between them; the radial sealing surfaces on the male and female members are tapered and positioned at an angle of 71-73° to the normal line to the central axis of the thread, and the thickness of the stop end of the male member constitutes at least 50% of the wall thickness of the male member.
